(19) United States
(12) Patent Application Publication
(10) Pub. No.: US 2014/0364258 A1
(43) Pub. Date: Dec. 11, 2014

(54) SYSTEM FOR DRIVING A WATER PUMP AND MOUNTING METHOD

(71) Applicant: Aktiebolaget SKF, Goteborg (SE)

(72) Inventors: Romuald Lescorail, St. Laurent en Gatines (FR); Nicolas Tronquoy, Fondettes (FR)

(73) Assignee: Aktiebolaget SKF, Goteborg (SE)

(21) Appl. No.: 14/299,372

(22) Filed: Jun. 9, 2014

(30) Foreign Application Priority Data
Jun. 7, 2013 (FR) 1355291

(51) Int. Cl. F16H 7/02; F16H 55/36

(52) U.S. Cl. CPC F16H 7/02; F16H 55/36
USPC 474/150

(57) ABSTRACT

The present invention provides a system for driving a water pump. The system includes a driveshaft, a case containing the water pump, a bearing including a stationary ring that is stationary relative to the case and a rotating ring secured in rotation with the driveshaft. The system further includes a drive belt, at least one rolling path for the drive belt, the rolling path being secured in rotation with the rotating ring, and a flange transmitting the torque from the rotating ring to the drive shaft. The flange is made from plastic and is overmolded both on the rotating ring and on the driveshaft. The invention also relates to a mounting method for such a system.

### CROSS-REFERENCE TO RELATED APPLICATIONS

This application claims priority to French Application FR1355291 filed Jun. 7, 2013, the contents of which are herein fully incorporated by reference.

### FIELD OF THE INVENTION

The present invention relates to a system for driving a water pump, as well as a method for mounting such a system.

### BACKGROUND OF THE INVENTION

In a known manner, water pumps are driven using a drive system including a pulley secured to the driveshaft of the pump and a belt mounted on the pulley to transmit a torque and a rotational movement. A bearing is generally inserted between the driveshaft and the pulley. The transmission of the torque requires a very low concentricity allowance between the rotating ring of the bearing and the driveshaft. The multiplicity of parts in the assembly of the drive system increases the risks of concentricity faults.

EP-A-1,788,254, FR-A-2,979,395 and FR-A-2,979,397 describe different systems for driving a water pump. Each of these systems includes a metal flange connecting the driveshaft and the rotating ring of the bearing. The rolling path for the belt is formed by the rotating ring or the flange, thus performing a pulley function.

In practice, the use of the metal flange makes it possible to obtain a strong driving system. Nevertheless, low machining allowances are necessary to facilitate the assembly between its component elements in order to satisfy the required geometric parameters, such as the coaxiality or concentricity allowances. Furthermore, such a metal flange increases the weight and cost of the system.

### SUMMARY OF THE INVENTION

The aim of the present invention is to propose an improved drive system, resolving the aforementioned drawbacks.

To that end, the invention relates to a drive system for driving a water pump, comprising:
a driveshaft;
a case containing the water pump;
a bearing including a stationary ring that is stationary relative to the case and a rotating ring secured in rotation to the driveshaft;
a drive belt;
at least one rolling path for the drive belt, that rolling path being secured in rotation with the rotating ring; and
a flange transmitting the torque from the rotating ring to the driveshaft.

The drive system is characterized in that the flange is made from plastic and is overmolded both on the rotating ring and on the driveshaft.

Thus, the invention makes it possible to reduce the weight and cost of the drive system. Compared with a metal flange, the crimping, welding or threading operations provided for the assembly of the flange with the driveshaft and/or the rotating ring of the bearing are avoided. Using a plastic flange by overmolding is therefore less costly, while making it possible to obtain satisfactory machining allowances.

According to other advantageous features of the drive system according to the invention, considered alone or in combination:

The flange is a single piece, a first part and a second part of the flange being overmolded simultaneously on the rotating ring and on the shaft, respectively.

A first part of the flange at least partially covers an outer surface of the rotating ring and makes up at least part of the rolling path.

The first part of the flange makes up all of the rolling path.

The first part of the flange partially covers the outer surface of the rotating ring, preferably the first part covers between 30% and 70% of the outer surface, still more preferably between 40% and 60% of the outer surface.

A first part of the flange is overmolded on drawn paths forming at least part of the rolling path secured in rotation with the rotating ring.

The flange includes stiffening ribs, in particular connecting a radial part with a first outer part and/or a second inner part.

The drive system comprises anti-rotation means and/or means preventing axial extraction of the flange relative to the shaft and/or relative to the rotating ring.

The invention also relates to a method for mounting a drive system for driving a water pump, comprising:
a driveshaft;
a case containing the water pump;
a bearing including a stationary ring that is stationary relative to the case and a rotating ring secured in rotation to the driveshaft;
a drive belt;
at least one rolling path for the drive belt, that rolling path being secured in rotation with the rotating ring; and
a flange transmitting the torque from the rotating ring to the drive shaft.

The method is characterized in that it comprises a first step of overmolding the plastic flange at least on one end of the rotating ring, and a second step of overmolding the plastic flange on at least one end of the driveshaft.

According to one particular embodiment of the method, when the flange is a single piece, the first overmolding step and the second overmolding step are simultaneous, whereas the shaft and bearing are positioned in a same mold.

### BRIEF DESCRIPTION OF THE DRAWINGS

The invention will be better understood upon reading the following description, provided solely as a non-limiting example and done in reference to the appended drawings, in which:

FIG. 1 is a perspective view of a drive system, according to the invention, for a water pump;

FIG. 2 is an axial view along arrow II in FIG. 1;

FIG. 3 is a longitudinal cross-section of the drive system along line III-III in FIG. 2;

FIG. 4 is a view similar to FIG. 3, showing a first alternative embodiment of the invention; and

FIG. 5 is a cross-section similar to FIGS. 3 and 4, showing a second alternative embodiment of the invention.

### DETAILED DESCRIPTION OF THE INVENTION

FIGS. 1 to 3 show a drive system 1 according to the invention, provided to drive a water pump P.

The drive system 1 comprises a driveshaft 10, a case 20, a bearing 30, a drive belt 50 and a flange 60. The shaft 10 centered on a central longitudinal axis X1 drives the water pump P housed in the case 20. The bearing 30 includes a stationary inner ring 32 and a rotating outer ring 40 that are centered on the axis X1.

The driveshaft 10 is rotated around the axis X1 by the flange 60, which is driven by the rotating ring 40, which is driven by the belt 50. In other words, the belt 50, the rotating ring 40, the flange 60 and the shaft 10 are secured in rotation around the axis X1. The shaft 10 includes a cylindrical part 11 centered on the axis X1. On the side opposite the pulley P along the axis X1, the shaft 10 has one end 12 configured to receive the flange 60. That end 12 comprises a fluted part 13, a globally convex part 14, and two slots 15 and 16 inserted between the parts 11, 13 and 14.

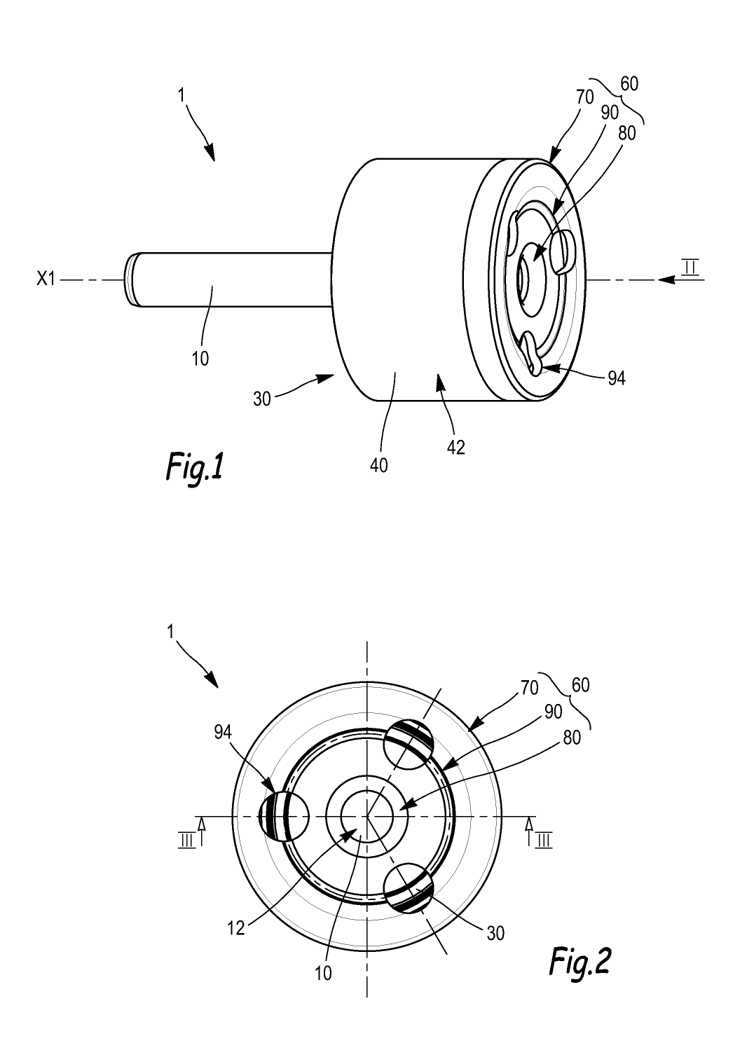

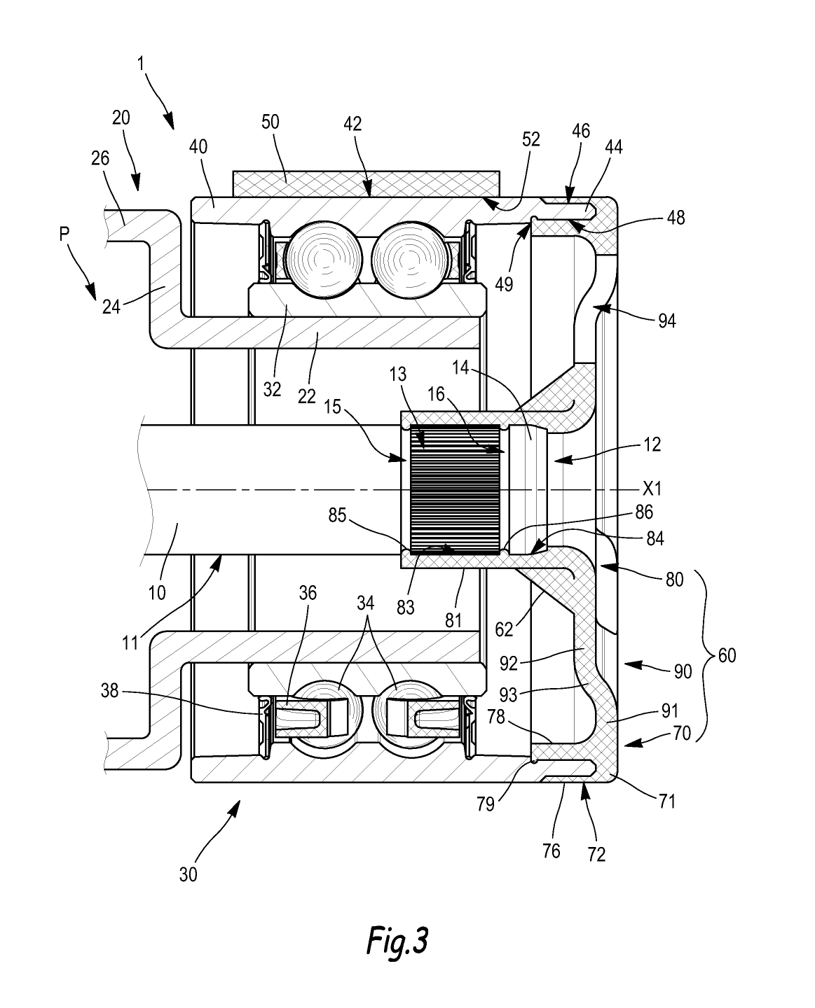

The case 20 comprises two cylindrical sleeves 22 and 26 centered on the axis X1 and connected by a radial part 24 to the axis X1. The case 20 is partially shown in FIG. 3 and is not shown in FIGS. 1 and 2 for simplification purposes. The case 20 at least partially surrounds the shaft 10. The sleeve 22 has an outer diameter smaller than that of the sleeve 26. The sleeve 22 receives the stationary ring 32 of the bearing 30 on its outer surface. The water pump mechanism, known in itself, is sealably contained in the case 20. The case 20 is preferably made from metal. Alternatively, the case 20 can have any shape and/or any material suitable for this application.

The bearing 30 comprises two rows of rolling elements 34, in this case beads, maintained by a bearing cage 36 in the bearing space delimited between the stationary ring 32 and the rotating ring 40. Alternatively, the rolling elements 34 can be different from beads, for example rollers or needles. Furthermore, the bearing 30 may include at least one row of rolling elements 34. Preferably, the bearing 30 includes sealing elements 38, for example sealing gaskets made from an elastomeric material, positioned on either side of the rolling elements 34. The stationary ring 32 is mounted on the sleeve 22 of the case 20 using any suitable means, for example by fitting.

The rotating ring 40 of the bearing 30 includes a cylindrical outer surface 42 that is centered on the axis X1 and forms a rolling path for the belt 50. On the side opposite the pump P along the axis X1, the ring 40 has one end 44 provided to receive the flange 60. At that end 44, on the outer side oriented radially opposite the axis X1, the ring 40 includes a recess 46 with an annular shape. The recess 46 has a diameter smaller than the surface 42 around the axis X1. Also at that end 44, on the inner side oriented radially toward the axis X1 and opposite the recess 46, the ring 40 includes a recess 48 and a groove 49, which each have an annular shape. The recess 48 has a diameter smaller than the groove 49 around the axis X1. In other words, the groove 49 penetrates the ring 40 more deeply than the recess 48 does.

The belt 50 can be driven by an electric motor or an internal combustion engine, not shown. The belt 50 is partially shown in FIG. 3 and is not shown in FIGS. 1 and 2, for simplification purposes. The belt 50 includes an inner surface 52 provided to cooperate with the outer surface 42 of the ring 40. The surface 42 is suitable for receiving the belt 50 so as to transmit the rotational torque to the flange 60 and the shaft 10.

Alternatively, the belt 50 may be of the notched type, in particular Poly-V, or any other type without going beyond the scope of the invention. The surface 42 of the ring 40 is then provided with raised portions, such as slots or ribs, so as to cooperate with the shape of the belt 50.

The flange 60 forms a mechanical connecting member between the rotating ring 40 and the driveshaft 10, allowing the transmission of the rotational torque. The flange 60 comprises an outer part 70, an inner part 80 and a radial intermediate part 90 connecting the parts 70 and 80. In the example of FIGS. 1 to 3, the flange 60 is a single piece comprising the parts 70, 80 and 90. The flange 60 is made from plastic, for example polyamide reinforced with glass or carbon fibers. In addition to its torque transmission function, the flange 60 forms a protective cap for the pump P housed in the case 20.

The outer part 70 is overmolded on the end 44 of the rotating ring 40. The outer part 70 includes a radial portion 71 that extends globally radially to the axis X1 from the part 90, while bordering the end 44 of the ring 40. The outer part 70 also includes two tubular portions 76 and 78 that extend from the portion 71 globally parallel to the axis X1 on either side of the end 44 of the ring 40, toward the pump P. The portions 76 and 78 are respectively received in the recesses 46 and 48 of the ring 40. The portion 76 includes an outer surface 72 that is flush at the same level as the outer surface 42 radially to the axis X1. The portion 78 comprises a bead 79 penetrating the groove 49 during overmolding. The groove 49 and the bead form means preventing axial extraction of the outer part 70 of the flange 60 relative to the rotating ring 40 of the bearing 30. Alternatively and/or complementarily, the rotating ring 40 and/or the flange 60 may include means preventing rotation of the outer part 70 relative to the rotating ring 40.

The inner part 80 is overmolded on the end 12 of the driveshaft 10. The inner part 80 comprises a tubular portion 81 that extends globally parallel to the axis X1 from the part 90. At its inner surface turned toward the axis X1, the portion 81 comprises a slotted part 83 overmolded on the fluted part 13, a concave part 84 overmolded around the convex part 14, and two beads 85 and 86 respectively overmolded in the grooves 15 and 16. Thus, the inner part 80 is rigidly secured to the end 12 of the shaft 10, both axially and in rotation around the axis X1. The portion 78 comprises a bead 79 penetrating the groove 49 during overmolding. In other words, the parts 13 and 83 form means preventing rotation of the inner part 80 of the flange 60 relative to the end 12 of the shaft 10, while the elements 14, 15, 16, 84, 85 and 86 form means preventing axial extraction of the inner part 80 of the flange 60 relative to the end 12 of the shaft 10.

The radial part 90 includes two radial portions 91 and 92 connected by an inclined portion 93. The radial part 90 includes orifices 94, more specifically three orifices 94 distributed regularly around the axis X1 in the example of FIGS. 1 to 3. The orifices 94 are formed through the radial part 90 to allow the passage of a tool, in particular during the assembly of the bearing 30 on the case 20.

As shown in FIG. 3, the flange 60 includes stiffening ribs 62 connecting the inner part 80 and the radial part 90, in this case connecting the portions 81 and 92. Alternatively and/or complementarily, the flange 60 may include stiffening ribs connecting the outer part 70 and the radial part 90, for example connecting the portions 78 and 91.

According to the invention, the method for mounting the system 1 comprises a first step for overmolding the first part 70 of the flange 60 made from plastic at least on the end 44 of the rotating ring 40 and a second step for overmolding the second part 80 of the flange 60 made from plastic on at least the end 12 of the driveshaft 10.

Preferably, the first overmolding step and the second overmolding step are simultaneous, while the shaft 10 and the bearing 30 are positioned in a same mold. The plastic material of the flange 60 is injected during a same operation on the dedicated zones of the shaft 10 and the ring 40 to form the single-piece flange 60.

Alternatively, the first and second overmolding steps can be done successively and not simultaneously. In that case, the method comprises a step for securing the first part 70 and the second part 80 of the flange 60 after the overmolding steps, for example by gluing or clipping.

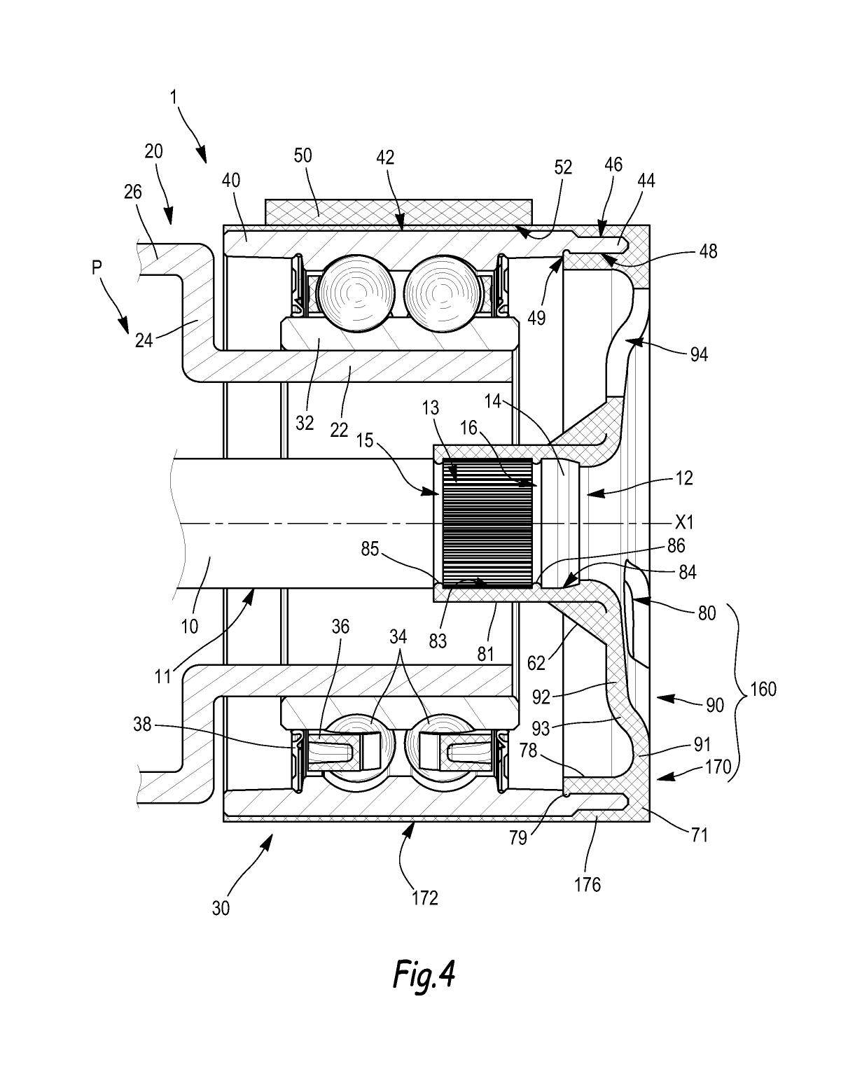

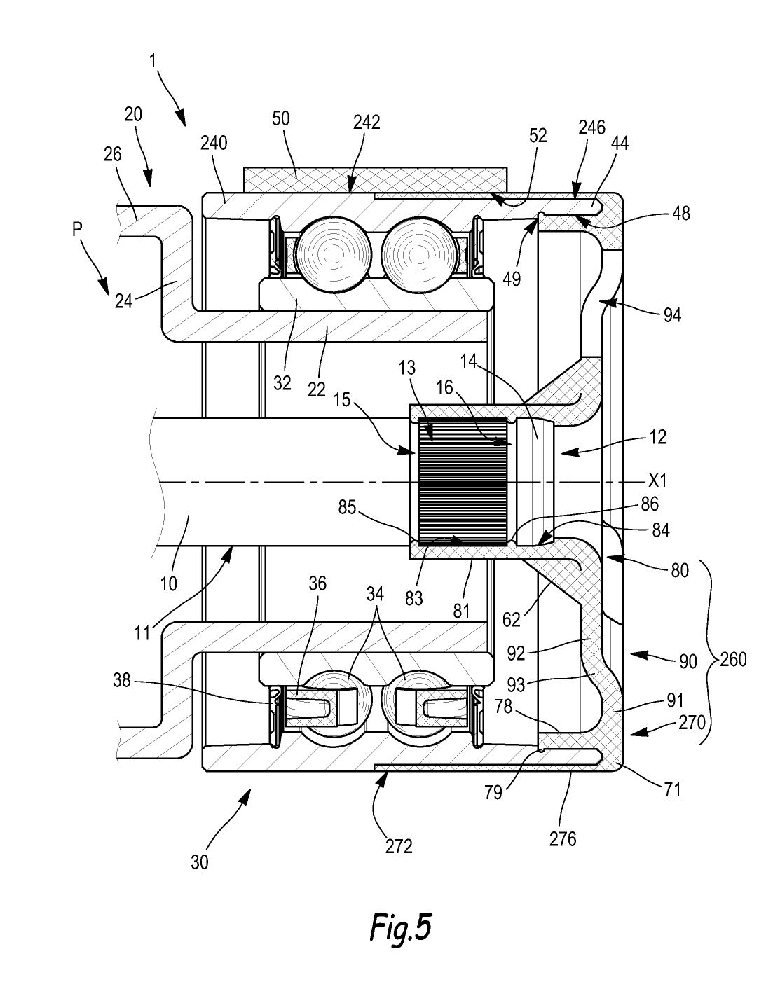

FIGS. 4 and 5 show alternative embodiments of the invention. For simplification purposes, the component elements of the system 1 bear the same reference numbers as in the embodiment of FIGS. 1 to 3, described above, and only the structural and/or functional differences are described below.

In FIG. 4, the system 1 comprises a flange 160 including an outer part 170 more extended along the axis X1 than the outer part 70 described above. The outer part 170 includes a tubular portion 176 that extends parallel to the axis X1 in the recess 46 and along the surface 42 of the rotating ring 40. The portion 176 covers the outer surfaces 42 and 46 of the rotating ring 40. The portion 176 includes a cylindrical outer surface 172 that is centered on the axis X1 and forms a rolling path for the belt 50. In other words, the surface 172 of the outer part 170 constitutes the entire rolling path of the belt 50. This rolling path 172 receives the surface 52 of the belt 50 and is secured in rotation with the rotating ring 40.

In FIG. 5, the system 1 comprises a rotating ring 240 in which a recess 246 is formed that is more extended along the axis X1 than the recess 46. In the case at hand, the recess 246 extends from the end 44 of the rotating ring 240 up to a zone situated substantially between the rows of rolling elements 34 radially to the axis X1. Under these conditions, the rotating ring 240 includes an outer surface 242 that is less extended along the axis X1 than the surface 42. Furthermore, the system 1 comprises a flange 260 including an outer part 270 more extended along the axis X1 than the outer part 70 and less extended than the outer part 170 described above. The outer part 270 includes a tubular portion 276 that extends parallel to the axis X1 in the recess 246, without encroaching on the surface 242 of the rotating ring 240. In other words, the portion 276 partially covers the outer surfaces 242 and 246 of the rotating ring 240. Preferably, the portion 276 covers between 30% and 70% of the outer surface 242+246 of the ring 240, still more preferably between 40% and 60% of the outer surface 242+246 of the ring 240. The portion 276 includes a cylindrical outer surface 272 that is centered on the axis X1 and flush at the same level as the outer surface 242 radially to the axis X1. Thus, the surfaces 242 and 272 together form the rolling path of the belt 50. This rolling path 242+272 receives the surface 52 of the belt 50 and is secured in rotation with the rotating ring 240.

Furthermore, the system 1 can be configured differently from FIGS. 1 to 5 without going beyond the scope of the invention. For simplification purposes, the description below is done in reference to the embodiment of FIGS. 1 to 3, with the understanding that the explanations are valid for the embodiments of FIGS. 4 and 5.

In an alternative that is not shown, the flange 60 is not a single piece. In that case, the outer part 70 and the outer part 80 of the flange 60 can be secured to one another after their respective overmolding on the rotating ring 40 and on the driveshaft 10, using any securing means suitable for the present application, for example by gluing or clipping.

According to another alternative that is not shown, the system 1 may include all types of anti-rotation means and/or means for preventing axial extraction formed between the shaft 10 and the flange 60 and/or between the rotating ring 40 and the flange 60, for example grooves, slots, flutings, striations, etc.

Irrespective of the embodiment, the flange 60 includes a first part 70 overmolded at least on the end 44 of the rotating ring 40 and a second part 80 overmolded at least on the end 12 of the driveshaft 10. Such a flange 60 made from a plastic material overmolded on the one hand on the shaft 10 and on the other hand on the rotating ring 40 allows a cost reduction, a decreased weight of the assembly including the pump P and its drive system 1, while allowing an improvement in the geometric allowances compared with a traditional metal flange.

Furthermore, all or some of the technical features of the different embodiments can be combined. Thus, the system 1 can be adapted in terms of cost, functionality and performance.

1. A drive system for driving a water pump (P), comprising:
a driveshaft;
a case containing the water pump (P);
a bearing including a stationary ring that is stationary relative to the case and a rotating ring secured in rotation to the driveshaft;
a drive belt;
at least one rolling path for the drive belt, the rolling path being secured in rotation with the rotating ring; and
a flange transmitting the torque from the rotating ring to the driveshaft; wherein
the flange is made from plastic and is overmolded both on the rotating ring and on the driveshaft.

2. The drive system according to claim 1, wherein the flange is a single piece having a first part and a second part of the flange, the first part and the second part of the flange being overmolded simultaneously on the rotating ring and on the shaft, respectively.

3. The drive system according to claim 1, wherein a first part of the flange at least partially covers an outer surface of the rotating ring and encompasses at least part of the rolling path.

4. The drive system according to claim 3, wherein the first part of the flange encompasses the entire rolling path.

5. The drive system according to claim 3, wherein the first part of the flange covers between 30% and 70% of the outer surface of the rotating ring.

6. The drive system according to claim 1, wherein a first part of the flange is overmolded on drawn paths forming at least part of the rolling path secured in rotation with the rotating ring.

7. The drive system according to claim 1, wherein the flange includes stiffening ribs that connect a radial part with at least one of a first outer part and a second inner part.

8. The drive system according to claim 1, further comprising at least one of an anti-rotation means and a means for preventing axial extraction of the flange relative to the shaft and/or relative to the rotating ring.

9. A method for mounting a drive system for driving a water pump (P), comprising:
providing a driveshaft; a case containing the water pump (P); a bearing including a stationary ring that is stationary relative to the case and a rotating ring secured in rotation to the driveshaft; a drive belt; at least one rolling path for the drive belt, that rolling path being secured in rotation with the rotating; and a flange transmitting the torque from the rotating ring to the driveshaft; the method comprising,
overmolding the plastic flange at least on one end of the rotating ring, and
overmolding the plastic flange on at least one end of the driveshaft.

10. The mounting method according to claim 9, wherein the flange is a single piece and the first overmolding step and the second overmolding step are simultaneous, and wherein the shaft and bearing are positioned in a same mold.

11. The drive system according to claim 3, wherein the first part of the flange partially covers between 40% and 60% of the outer surface of the rotating ring.
